(19) United States
(12) Patent Application Publication
(10) Pub. No.: US 2018/0246882 A1
(43) Pub. Date: Aug. 30, 2018

(54) Real time speech translation system

(71) Applicant: Divine Connect, LLC, West Palm Beach, FL (US)

(72) Inventor: Mohamed S. Pazhoor, West Palm Beach, FL (US)

(21) Appl. No.: 15/445,321

(22) Filed: Feb. 28, 2017

(51) Int. Cl. G06F 17/28; G06F 3/16; H04H 60/15; H04H 20/57; H04H 20/72

(52) U.S. Cl. CPC G06F 17/289; G06F 3/16; H04H 20/72; H04H 20/57; H04H 60/15

(57) ABSTRACT

The present invention relates to translation devices and, more particularly, to a speech translation system that includes a group of live translators, a broadcasting tower and a handset device which enables a user to access a broadcast translation in real time from a remote location on the handset device. The broadcast translation is translated into a plurality of different languages in real time, which allows a handset holder to choose a desired language for receiving the real time translations which are broadcast simultaneously.

### FIELD OF THE INVENTION

The present invention generally relates to speech translation systems; and more particularly, to a system for translating spoken words in real time for rebroadcast over a private network to a handset constructed to only receive transmissions over the private network.

### BACKGROUND OF THE INVENTION

Speech translation is the process by which spoken or written words, phrases, or sentences are translated and either spoken aloud or written in a different language. This differs from phrase translation, which is where a system only translates a fixed and finite set of words or phrases that have been manually entered into a system. Speech translation technology enables speakers of different languages to communicate to a larger audience, thereby making speech translation of tremendous value in terms of science, cross-cultural exchange, and global business.

Devices for participants of an event to participate in the event by responding to questions or polling are known. Participants can be provided with handsets, which enable the participants to respond to questions, participate in a poll, place a vote, or the like. These devices enable the event organizers to gather immediate feedback from the participants to gauge interest, view poll results, etc. One of the drawbacks associated with most large events is that not all the participants speak or fully understand the language of the speaker, thereby making it difficult for the participant to understand the subject matter being discussed and intelligently participate in questions or polling. Even in events that do not require the use of devices for the sake of responding to questions or polling, it is important for organizers and participants to provide a means for the participants to be engaged in and understand what is being discussed by the speaker.

Currently, many speech translation devices translate speech using computer automated translation systems. These systems are often capable of translating continuous speech, provided the speaker talks directly into the device and enunciates without a dialect or accent. Moreover, these computer translation systems are severely affected by external factors such as acoustic noise, crowd noise, reverberation in the acoustic system, echo and background noise, which may include vehicles, planes, machinery, etc. As such, using live translators mitigates errors associated with the computer automated translation systems.

Prior art translation devices for the translation of text from one language to another involve the use of dictionaries to translate on a word-by-word basis. This approach is slow and subject to inaccuracies arising from a lack of context for the individual words being translated. Literal translations lead to sub-optimal translations of modern terms and phrases because context is not considered. Additionally, the reader/audience is more concentrated on reading the interpreted text rather than viewing the speaker, speaker's body language, media presentation, general audience atmosphere, and the like. There remains a need for a device that can simultaneously translate an event and, in real-time audibly convey that translation to an interested party in their native language instead of text translation.

There is a need in the art to provide a speech translation system that includes handset devices where participants or remotely located enthusiasts who are interested in or wish to listen to a live presentation may simultaneously tune into the presentation using the handset device, and have the speech simultaneously translated in real-time into the selected language the user selects, thereby broadening the audience the event organizers seek to target and allowing enthusiasts to listen to a variety of conferences, presentation, lectures, or the like in their native language from a remote location.

### SUMMARY OF THE INVENTION

The present invention relates to translation devices and, more particularly, to a speech translation system that includes a group of live translators, a broadcasting tower and a handset device which enables a user to access a broadcast translation in real time from a remote location on the handset device. The broadcast translation is translated into a plurality of different languages in real time, which allows a handset holder to choose a desired language for receiving the real time translations that are broadcast simultaneously. The speech translation system utilizes a radio frequency or wireless signal transmission between transmitters and receivers. The frequencies are chosen so that only holders of the handset device may receive the signals. In this manner, the handsets can be rented, leased or purchased for specific events, and only these devices can then receive the translated signals. In use, a speaker speaks into a microphone, also known as the floor feed, in one language; the floor feed is then broadcasted to a plurality of interpreters who listen through headphones in a separate location; the interpreters simultaneously speak into a microphone in a translated language, which is broadcast to the handset device over a limited area; the handset user can then hear the proceedings in their native language by choosing which language they want to hear. The language is chosen by selecting a button or emblem representing a specific language or dialect on the handheld device. This construction allows the same handset to be utilized simultaneously for several different languages or dialects. At very large events, more than one speaker may be speaking at the same time. At these events, the handset may also include buttons or icons that can be selected to allow a choice of which speaker and which language or dialect is heard from the handheld device.

Accordingly, it is an objective of the present invention to provide a speech translation system for translating spoken words in real time for rebroadcast over a private network to a handset constructed to only receive transmissions over the private network.

Another objective of the present invention is to allow a user to select from a variety of conferences, presentations, and lectures that may be occurring and being translated simultaneously.

Yet another objective of the present invention is to allow the user to select their language of choice and then hear the speech translated in their selected language from a real time translation.

Still yet another objective of the present invention is to provide a system whereby a speaker's words are transmitted to a group of interpreters, the interpreters listen to the speaker and at the same time provide an interpretation of what has just been said, which is transmitted to a plurality of handset devices in a variety of languages.

A further objective of the present invention is to provide a system that utilizes radio frequency or wireless signal to transmit to a plurality of handset devices in a private network.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a pictorial representation of the speech translation system;

FIG. 2 is a perspective view of the handset device of the instant invention;

FIG. 3 is a rear elevation view of the handset device shown in FIG. 2;

FIG. 4 is a first side elevation view of the handset device shown in FIG. 2;

FIG. 5 is a second side elevation view of the handset device shown in FIG. 2;

FIG. 6 is a top plan view of the handset device shown in FIG. 2; and

FIG. 7 is a bottom plan view of the handset device shown in FIG. 2.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

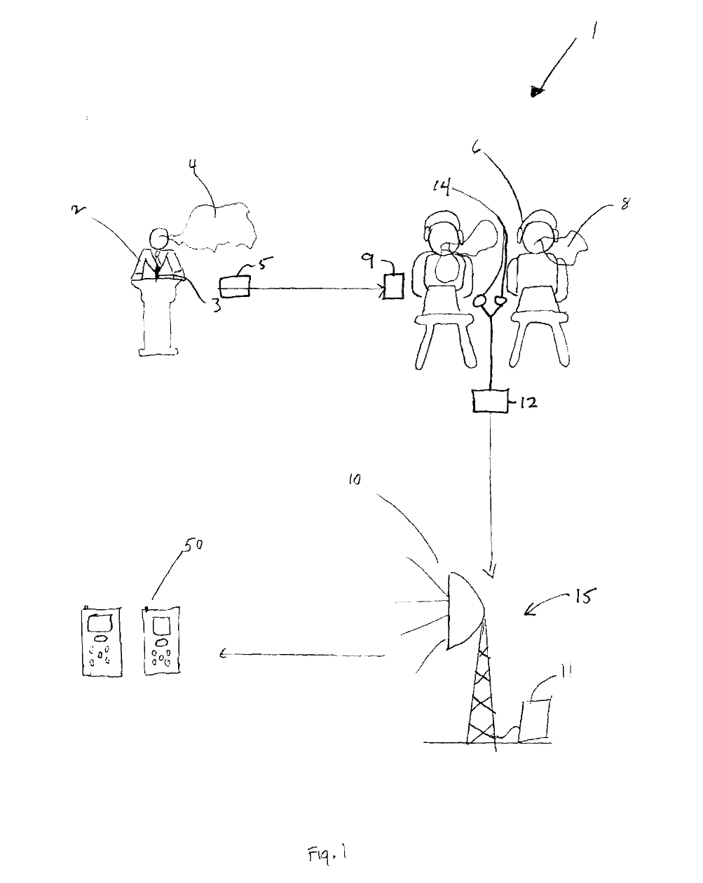

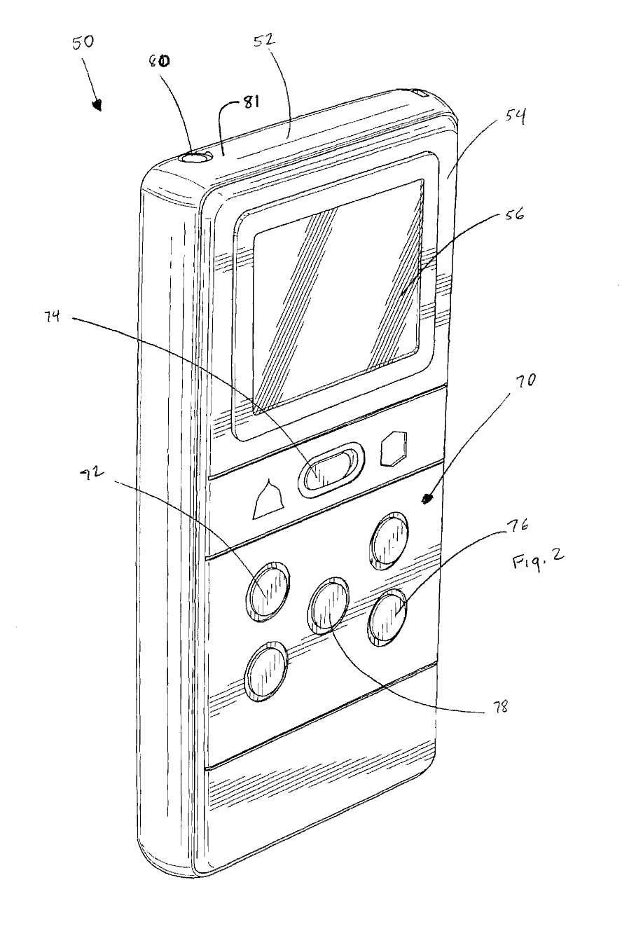

Referring now to FIGS. 1 and 2, a speech translation system 1 for real time translation of spoken word and rebroadcast over a private network is disclosed. The system 1 includes an event speaker 2, at least one interpreter 6, a radio broadcast antenna 10, and a handset device 50. In the preferred embodiment, the event speaker 2 speaks in his native tongue or a language in which he is a fluent speaker. This speech may be broadcast to large or small crowds over a standard amplified system as is known in the art. The speech is simultaneously directed to at least one, and preferably a plurality of interpreters 6 which interpret what the speaker is saying and convert the speaker's language into at least one other language, which may require modifying grammar, syntax etc. The microphone 3 and its associated transmitter 5 are coupled for communication with one or more receivers 9, allowing the interpreters to hear the spoken words of the interpreter 6 and then translate the words in real time for further transmission by a transmitter 12 coupled to the broadcast station 11 and its antenna 10. The broadcast station 11 and antenna 10 form a transmitter 15 to broadcast the translated words to the handset(s) 50 which are receivers. The interpreted and converted language(s) are electronically transmitted to a broadcast station 11 for transmission through radio waves. The radio transmission is preferably via a low energy radio transmission device that utilizes private and/or select radio frequencies that are not easily or readily intercepted and may be encrypted. Handset devices 50 are sold, rented, handed out or otherwise distributed. The handset devices 50 include electronics that are constructed and arranged to communicate with the antenna 10 by receiving the radio signals emanating from the private broadcast antenna 10. In some embodiments, the handset may be constructed to accept encrypted messages, which are descrambled and broadcast through the handset device 50 in real time. In a most preferred embodiment, the handset device 50 includes a plurality of buttons and/or switches that allow the user to select a desired language for broadcast through the handset.

As shown in FIG. 1, in use, a speaker 2 speaks into a microphone 3, providing the microphone feed 4 of spoken words in one language. The microphone feed 4 is then electronically transferred to a plurality of interpreters 6, who listen to the microphone feed 4, preferably through headphones in a separate location. The interpreter(s) 6 listens to the microphone feed 4 and simultaneously speaks words, each into a respective microphone 14 in an interpreted language 8, which is different than the microphone feed 4. The interpreted language is then electronically transferred to a portable broadcast station 11, which is converted to radio signals for broadcast through antenna 10. The signals are then received by the handset device 50 in which the user can switch the language that is being heard through the handset by selection of a button or icon on the device. The user is not limited to one proceeding. The speech translation system 1 allows for the user to select from various proceedings, which may be occurring at the same time, so long as the handheld device is within radio range of an interpreted broadcast.

The microphone 3, receiver 9, microphone(s) 14, transmitter 12, broadcast station 11 and handset(s) 50 are coupled for communication, preferably wirelessly.

The speech translation system 1 utilizes a radio frequency or wireless signal transmission between transmitters and handset devices 50. The distance range of the audience to cover will typically determine the transmission system that will be utilized. For small distance ranges, a wireless transmission will suffice; however longer distances may require a powerful FM transmission. In at least one embodiment, each of the handset devices includes a chip, such as a ZIGBY chip, which provides for relay communication between the antenna and each of the handset devices. In this manner, so long as the handset devices are within range of the handset device, the signal will be relayed along an indefinite range.

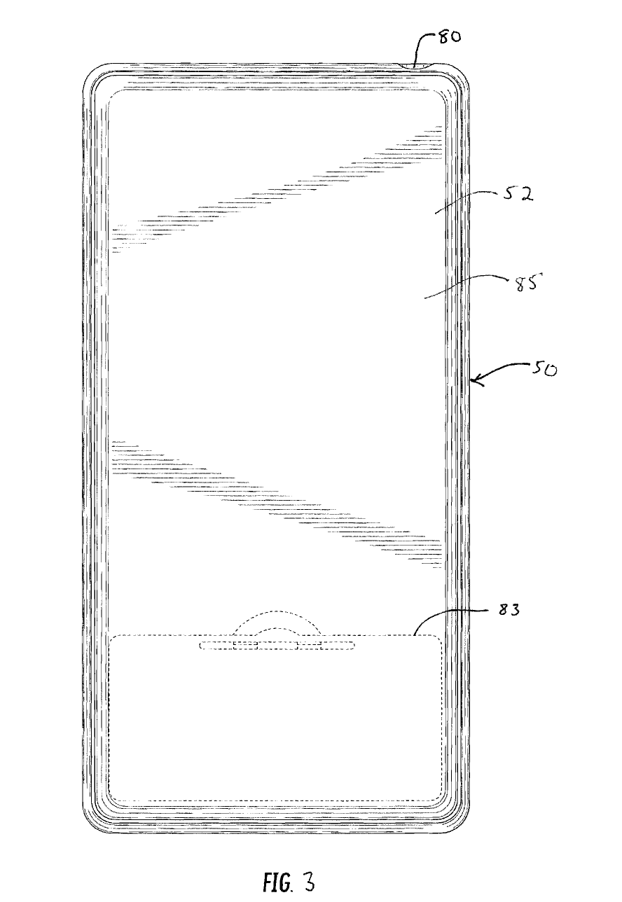

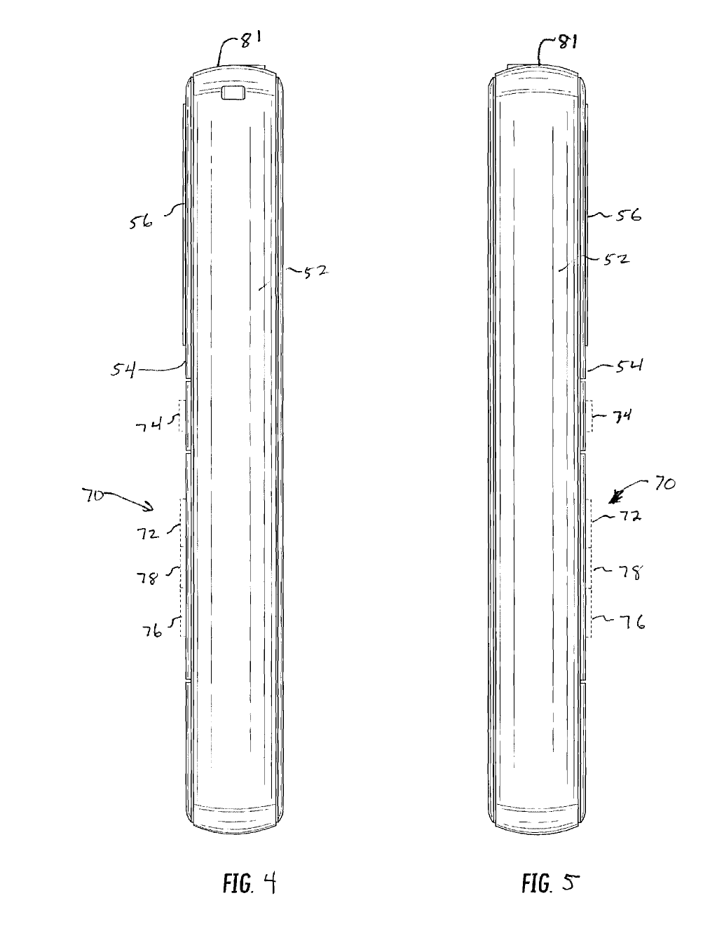

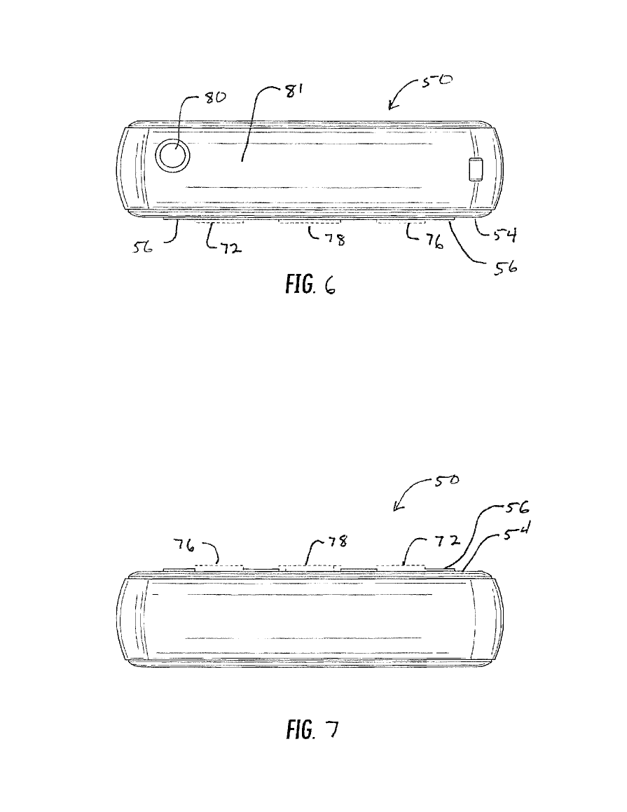

As shown in FIG. 2, the handset device 50 includes a housing 52 having a front face 54 providing a plurality of buttons 70 and a screen 56 thereon. The handset 50 is not limited to the buttons described, as other buttons can be used without departing from the scope of the invention. On the front face 54 are a pair of volume control buttons 72 for increasing and decreasing the volume emitted into the earphones. Also included is a toggle switch button 74 for choosing between various proceedings that may be occurring. A pair of channel buttons 76 is provided so that the user can select from the plurality of translated languages. Additionally, a power button 78 is provided for turning the handset device 50 ON and OFF. The housing 52 also includes an audio jack 80 for pairing with earphones so that the user can listen to the floor feed in their translated language. The jack 80 is exposed on a top panel 81 of the handset 50. The screen 56 can provide information regarding the various languages the user can choose from, as well as volume level or the like. As seen in FIG. 3, the handset 50 can also be provided with an access door 83 to a battery chamber or internal components. The access door 83 is in a back panel 85 of the handset 50.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention, which are obvious to those skilled in the art, are intended to be within the scope of the following claims.

What is claimed is:

1. A language translation system comprising:
a microphone adapted to pick up first spoken words from a speaker;
a first transmission device associated with the microphone and adapted to transmit the first spoken words to a receiving device usable by a translator to receive the spoken words;
a second transmission device adapted to transmit second spoken words from the translator to a third transmission device, said third transmission device being adapted to transmit second spoken words to at least one handset receiving device;
said microphone, said first transmission device, said second transmission device, said third transmission device and said handset being coupled wirelessly for communication; and
said handset being constructed to allow a user to select a desired language for the second spoken words.

2. The system of claim 1 including a plurality of said second transmission devices each constructed to transmit different sets of second spoken words, and said third transmission device being constructed to simultaneously transmit said different sets of second spoken words.

3. The system of claim 2 including a plurality of said handset receiving devices each in communication with said third transmission device.

4. A method of providing translated spoken words, the method including:
transmitting a first set of spoken words wirelessly from a microphone through a first transmitter to at least one translator through a first receiver;
said translator translating said first set of spoken words to a second set of spoken words in a different language;
transmitting said second set of spoken words from a second transmitter to a third transmitter; and
transmitting said second set of spoken words from said third transmitter to a handset, allowing a user to listen to said second set of words in a selected different language.

5. The method of claim 4 wherein said translator including a plurality of translators and translating said first set of spoken words into a plurality of second sets of spoken words, each said second set of words being different languages from one another.

6. The method of claim 5 wherein said user including a plurality of users and each said user selecting a desired language on the user's handset.

7. The method of claim 6 wherein said third transmitter including a private broadcast station.

8. The method of claim 6 wherein said first transmitter, said second transmitter and said third transmitter communicate wirelessly.

9. The method of claim 6 wherein the translating and transmitting to said users being in real time.
